(19) United States
(12) Patent Application Publication
(10) Pub. No.: US 2006/0283290 A1
(43) Pub. Date: Dec. 21, 2006

(54) Method of manufacturing magnetic particles, magnetic particles, and magnetic recording medium

(75) Inventors: Yasushi Hattori, Kanagawa (JP); Koukichi Waki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/455,764

(22) Filed: Jun. 20, 2006

(30) Foreign Application Priority Data
Jun. 21, 2005 (JP) 2005-181055
Feb. 22, 2006 (JP) 2006-045207

(51) Int. Cl. H01F 1/06

(52) U.S. Cl. 75/348; 148/105; 148/230; 148/306

(57) ABSTRACT

A method of manufacturing magnetic particles, the method comprising synthesizing iron particles in a liquid phase, nitriding the iron particles, adjusting the average particle diameter to 5 to 25 nm, and making the iron particles substantially spherical. Also provided are magnetic particles and magnetic recording media.

### CROSS-REFERENCE TO RELATED APPLICATION

This application claims priority under 35 USC 119 from Japanese patent Application Nos. 2005-181055 and 2006-045207, the disclosures of which are incorporated by reference herein.

### BACKGROUND OF THE INVENTION

1. Field of the Invention:

The present invention relates to a method of manufacturing magnetic particles having a high coercive force, and more particularly to a method of manufacturing magnetic particles with excellently monodispersity of diameter and uniformity of magnetic properties, magnetic particles, and magnetic recording media.

2. Description of the Related Art:

The reduction in particle size of a magnetic material contained in the magnetic layer of a magnetic recording medium is important for achieving a high magnetic recording density. When magnetic recording media used widely as, for example, video tapes, computer tapes and disks, are formed from an equal mass of ferromagnetic material, one having a smaller particle size can suppress noise to a lowerer level.

When a magnetic material is divided into fine particles and has a smaller volume than the volume with which superparamagnetism is stable, thermal fluctuations make the particles superparamagnetic and unsuitable for magnetic recording. Studies have been made on the use of FePt, CoPt, and the like, which has strong crystalline magnetic anisotropy and a smaller stabilizing volume for superparamagnetism. However, they are expensive because of the precious metal they contain. Magnetic materials of rare earth elements, such as SmCo, are also expected to be useful owing to their high crystalline magnetic anisotropy; however, they are easily corroded.

Under these circumstances, fine particles of Fe₁₆N₂ have been studied. A method for synthesizing a powder of Fe₁₆N₂ has been proposed (see, for example, Japanese Patent Application Laid-Open (JP-A) No. 11-340023) in which the oxidized surface of an iron powder is reduced at a high temperature, and is nitrided in a stream of NH₃ gas. However, Fe₁₆N₂ produced by such a method has been soft magnetic.

As a method for obtaining hard magnetic Fe₁₆N₂ suitable for a magnetic recording medium, a method has been proposed in which pure iron formed by reducing iron oxide having a specific surface area of about 50 m²/g is nitrided in a stream of NH₃ gas to form a powder having a specific surface area of 10 to 20 m²/g (see, for example, JP-A No. 2000-277311 and “Magnetic Properties of a Fine Powder of Fe₁₆N₂” (Journal of The Magnetic Society of Japan, 25, 927-930 (2001)). However, the particles obtained has a smaller specific surface area due to the coarsening of particles which occurs when iron oxide is reduced at a high temperature.

Therefore, a method has been disclosed in which the surface of iron oxide is coated with a layer of a rare earth element and/or silicon or aluminum as a fusion inhibitor and then is reduced at a high temperature (see, for example, JP-A Nos. 2004-273094 and 2004-335019).

However, since Fe₁₆N₂ is a metastable phase, nitriding has to be performed at a low temperature not exceeding 200° C. When nitriding is performed after coating with a rare earth or the like, the coating layer hinders the diffusion of nitrogen. Further, a difference in thickness of the coating layer or the like causes difference in degree of nitriding, thereby causing non-uniformity in magnetic properties between particles.

### SUMMARY OF THE INVENTION

The present invention has been made in consideration of the above circumstances, and provides a method of manufacturing magnetic particles, magnetic particles, and magnetic recording media.

A first aspect of the present invention provides a method of manufacturing magnetic particles. The method includes synthesizing iron particles in a liquid phase, nitriding the iron particles, adjusting their average particle diameter to 5 to 25 nm, and making them substantially spherical.

The synthesis of the iron particles preferably includes synthesizing iron particles by conducting a reduction reaction with a mixture of a reverse micelle solution (II) and a reverse micelle solution (I). The reverse micelle solution (II) is prepared by mixing a water-insoluble organic solvent containing a surfactant and an aqueous solution of a reducing agent. The reverse micelle solution (I) is prepared by mixing a water-insoluble organic solvent containing a surfactant and an aqueous solution of a salt of iron. The synthesis of the iron particles preferably further includes forming an oxide coating.

A second aspect of the present invention provides magnetic particles containing at least a phase of Fe₁₆N₂ having an average particle diameter of 9 to 11 nm and a particle diameter variation coefficient of 15% or less. The Fe₁₆N₂ phase preferably has a coercive force of 197.5 to 237 kA/m (2,500 to 30,000 Oe) and a Ms·V of 5.2×10⁻¹⁶ to 6.5×10⁻⁶.

A third aspect of the present invention provides a magnetic recording medium containing the magnetic particles described above in a magnetic layer.

### DETAILED DESCRIPTION OF THE INVENTION

(1) Method of Manufacturing Magnetic Particles:

The method of the present invention for manufacturing magnetic particles includes synthesizing iron particles in a liquid phase and nitriding the iron particles. Each of the treatment for adjusting the average particle diameter of the particles to 5 to 25 nm and the treatment for making the particles substantially spherical are conducted during or before or after any of the synthesizing or the nitriding. These processes and other optional processes will be described.

(1) Synthesizing Iron Particles

Known methods for synthesizing iron particles include an alcohol reduction method using a primary alcohol, a polyol reduction method using a secondary or tertiary alcohol or a dihydric or trihydric alcohol, a thermal decomposition method, an ultrasonic decomposition method, and a reduction method with a strong reducing agent, when classified by the manner of precipitation. Known methods include, when classified by the reaction system, a method involving the presence of a polymer, a method using a high-boiling solvent, a method using a normal micelle, or a method using a reverse micelle.

According to the present invention, it is preferable to employ a reverse micelle method which enables formation of substantially spherical iron particles and facilitates the control of the particle diameter and thereby the formation of a monodispersed dispersion. In an exemplary embodiment, iron particles (iron nanoparticles) are synthesized by a reduction reaction with a mixture of a reverse micelle solution (II) prepared by mixing a water-insoluble organic solvent containing a surfactant and an aqueous solution of a reducing agent and a reverse micelle solution (I) prepared by mixing a water-insoluble organic solvent containing a surfactant and an aqueous solution of a salt of iron.

The term “substantially spherical” as used herein means that iron or magnetic particles have ratio of the length of the major axis to the length of the minor axis of 2 or less (preferably 1.5 or less) under TEM observation. The synthesizing of the particles will be described in detail. Unless the particles are substantially spherical, a single axis of easy magnetization occurs in each particle during the nitriding, thus undesirably gives the coexistence of easy magnetization axes along the major axes and along the minor axes in the group of particles.

In the synthesis, iron particles are manufactured by a reduction process in which a reduction reaction proceeds in a mixture of a reverse micelle solution (I) containing one or more metal compounds and a reverse micelle solution (II) containing a reducing agent, optionally followed by an ripening process in which the particles are ripened after the reducing process. Each process will now be described.

(Reduction Process)

First, a reverse micelle solution (I) is prepared by mixing a water-insoluble organic solvent containing a surfactant and an aqueous solution containing one or more metal compounds. The reverse micelle solution (I) contains an iron salt used to form iron particles.

The surfactant may be an oil-soluble surfactant. Examples thereof include sulfonate-containing surfactants (for example, AEROSOL OT (product of Wako Pure Chemical Industries Ltd.), quaternary ammonium salt-containing surfactants (for example, cetyltrimethyl ammonium bromide), and ether-containing surfactants (for example, pentaethylene glycol dodecyl ether).

An alkane or ether is preferred as the water-insoluble organic solvent in which the surfactant is dissolved. The alkane is preferably an alkane having 7 to 12 carbon atoms. More specifically, the alkane may be selected from heptane, octane, nonane, decane, undecane or dodecane. The ether is preferably diethyl ether, dipropyl ether, or dibutyl ether. The amount of surfactant in the water-insoluble organic solvent is preferably from 20 to 200 g/l.

The metal compound contained in the aqueous solution of a metal compound may be a nitrate, a sulfate, a hydrochloride, an acetate, a hydroacid of a metal complex having a chlorine ion as a ligand, a potassium salt of a metal complex having a chlorine ion as a ligand, a sodium salt of a metal complex having a chlorine ion as a ligand, an ammonium salt of a metal complex having an oxalate ion as a ligand, or the like. In embodiments of the invention, the metal compound can be arbitrarily selected from such substances.

The concentration of metal compound in the aqueous solution is preferably from 0.1 to 2,000 p mol/ml, and more preferably from 1 to 500 μmol/ml.

It is preferable to add a chelating agent to the aqueous solution of a metal compound to ensure the formation of particles with uniform composition. More specifically, the chelating agent may be DHEG (dihydroxyethylglycine), IDA (iminodiacetic acid), NTP (nitrilotripropionic acid), HIDA (dihydroxyethyliminodiacetic acid), EDDP (dihydrochloride of ethylenediaminedipropionic acid), BAPTA (tetrapotassium hydrate of diaminophenylethyleneglycoltetraacetic acid), or the like. The chelate stability constant (log K) is preferably 10 or less. The amount of chelating agent to be added is preferably from 0.1 to 10 moles (more preferably from 0.3 to 3 moles), per mole of metal compound (iron salt).

Then, a reverse micelle solution (II) containing a reducing agent is prepared. The reverse micelle solution (II) can be prepared by mixing a water-insoluble organic solvent containing a surfactant and an aqueous solution of a reducing agent. When two or more reducing agents are used, they can be mixed to prepare a reverse micelle solution (II); however, in view of the stability of the solution, working efficiency, etc., it is preferable to prepare separate reverse micelle solutions ((II′), (II″), etc.) by mixing the reducing agents separately in water-insoluble organic solvents, and then to mix the reverse micelle solutions appropriately.

The aqueous solution of a reducing agent is composed of, for example, water and at least one of alcohols, polyalcohols, H₂, HCHO, S₂O₆²⁻, H₂PO₂⁻, BH₄⁻, N₂H₅⁺, and H₂PO₃⁻. Only one reducing agent may be used, or two or more reducing agents may be used in combination. The amount of reducing agent in the aqueous solution is preferably from 3 to 50 moles per mole of metal salt.

As the surfactant and water-insoluble organic solvent used for the reverse micelle solution (II), those mentioned above for the use in the reverse micelle solution (I) can be mentioned.

The mass ratio of water to surfactant in each of the reverse micelle solutions (I) and (II) is preferably in the range of 0.5 to 20. When the mass ratio is from 0.5 to 20, the particles obtained can have an average particle diameter of 5 to 25 nm, and can be uniform iron particles which are unlikely to precipitate. The mass ratio is more preferably from 0.5 to 15, and still more preferably from 0.5 to 10.

The reverse micelle solutions (I) and (II) may have the same or different water/surfactant mass ratio(s), but preferably have the same mass ratio so as to make the system uniform.

The reverse micelle solutions (I) and (II) prepared as described are mixed together. Although the manner of mixing is not specifically limited, it is preferable to add the reverse micelle solution (I) to the reverse micelle solution (II) under stirring to form a mixture, in view of the uniformity of reduction. After mixing, a reduction reaction may be allowed to proceed at a constant temperature in the range of −5° C. to 30° C. A reduction temperature of −5° C. or more enables a uniform reduction reaction without the solidification of an aqueous phase. When the reduction temperature is 30° C. or less, coagulation or sedimentation is unlikely to occur, and the system is stabilized. The reduction temperature is preferably from 0° C. to 25° C., and more preferably from 5° C. to 25° C.

The term “constant temperature” as used herein means a temperature within the range of T−3° C. to T+3° C. provided T (° C.) represents the target temperature. It is to be understood that both of the upper and lower limits of T should fall within the reduction temperature range as stated above (−5° C. to 30° C.).

The duration of the reduction reaction is preferably from 1 to 30 minutes, and more preferably from 5 to 20 minutes, though the duration should be determined adequately in consideration of the amounts of the reverse micelle solutions (I) and (II), and the like.

The reduction reaction is preferably performed under stirring at as high a speed as possible (for example, about 3,000 rpm or higher) since the reduction reaction has a significant effect on the monodispersity of the particle diameter distribution of the iron particles. A preferred stirrer is a stirrer having a high shearing force, and more particularly a stirrer having a stirring blade having basically a turbine or paddle type structure and additionally having a sharp edge at the end of the blade or the portion contacting the blade, the blade being rotatable by a motor. More specifically, apparatuses such as DISSOLVER (product of Tokushu Kika Kogyo Co., Ltd.), OMNIMIXER (product of Yamato Chemical Industries Ltd.) and Homogenizer (product of SMT) are useful. When these apparatus are used, a stable dispersion liquid of monodispersed nanoparticles can be obtained.

After the reaction of the reverse micelle solutions (I) and (II), at least one dispersant having 1 to 3 amino or carboxyl groups is preferably added in the amount of 0.001 to 10 moles per mole of iron particles to be produced. When the amount of dispersant to be added is from 0.001 to 10 moles per mole of iron particles, the monodispersity of the iron particles can be improved, and coagulation can be prevented.

The dispersant is preferably an organic compound having a group that can be adsorbed on the surface of the synthesized nanoparticles. More specifically, the dispersant may be a compound having 1 to 3 amino, carboxyl, sulfonate or sulfinate groups. Only one dispersant may be used, or two or more dispersants may be used in combination.

The dispersant may be a compound represented by the structural formula R—NH₂, H₂N—R—NH₂, H₂N—R(NH₂)—NH₂, R—COOH, HOCO—R—COOH, HOCO—R(COOH)—COOH, R—SO₃H, HOSO₂—R—SO₃H, HOSO₂—R(SO₃H)—SO₃H, R—SO₂H, HOSO—R—SO₂H or HOSO—R(SO₂H)—SO₂H, in which R is a straight-chain, branched or cyclic saturated or unsaturated hydrocarbon residue.

The dispersant is particularly preferably oleic acid. Oleic acid is a surfactant well known in the stabilization of a colloid and is used for protecting iron nanoparticles. The relatively long chain of oleic acid gives important steric hindrance that cancels strong magnetic interaction between particles (oleic acid has an 18-carbon chain with a length of about 2 nm (about 20 angstroms) and has one double bond). Oleic acid is preferable as it is an inexpensive natural resource which is easily available from olive oil and the like. Oleylamine derived from oleic acid is a useful dispersant like oleic acid.

Similar long-chain carboxylic acids, such as erucic acid and linolic acid, are also usable like oleic acid (for example, one or more long-chain organic acids having 8 to 22 carbon atoms can be used).

The timing for the addition of the dispersant is not particularly limited, but is preferably between immediately after the reduction reaction and the start of the ripening which will be described below. The addition of the dispersant makes it possible to produce iron nanoparticles which are higher in monodispersity and free from coagulation.

(Ripening)

The ripening involves raising the temperature of the solution to an ripening temperature after the reduction reaction. The ripening temperature is preferably a constant temperature between 30° C. and 90° C., and may be higher than the temperature of the reduction reaction. Ripening time is preferably from 5 to 180 minutes. When the ripening temperature and the ripening time fall within the above ranges, coagulation and sedimentation are unlikely to occur, and the reaction proceeds to the completion to achieve a uniform composition. The ripening temperature and the ripening time are more preferably from 40° C. to 80° C. and from 10 to 150 minutes, and still more preferably from 40° C. to 70° C. and from 20 to 120 minutes.

The “constant temperature” has the same meaning as in the case of the reduction reaction (though the “ripening temperature” should be substituted for the “reduction temperature”). The ripening temperature is preferably at least 5° C. higher than the temperature of the reduction reaction, and more preferably at least 10° C. higher than the temperature of the reduction reaction, provided that the ripening temperature is within the range mentioned above (30° C. to 90° C.). When the ripening temperature is at least 5° C. higher than the reduction reaction temperature, the prescribed composition can be obtained.

Iron particles having the desired particle diameter can be obtained by the ripening in which the stirring speed is adequately controlled at the ripening temperature.

In a preferable embodiment, the ripened solution after the ripening is washed with a mixture of water and a primary alcohol, and then is subjected to a precipitation treatment with a primary alcohol to form a precipitate, and the precipitate is dispersed in organic solvent. The washing and dispersing removes impurities and improves coatability at the time a magnetic layer is formed on a magnetic recording media. Each of the washing and the dispersion may be performed at least once, preferably at least twice.

The primary alcohol used for the washing is not particularly limited, but is preferably methanol, ethanol, or the like. The ratio (by volume) of water to primary alcohol (water/primary alcohol) is preferably in the range of 10/1 to 2/1, and more preferably in the range of 5/1 to 3/1. A higher proportion of water sometimes makes it difficult to remove the surfactant, while a higher proportion of primary alcohol sometimes causes coagulation.

The presence of a protective colloid during the precipitation of iron particles by reduction or under heat enables the stable preparation of iron particles. As to precipitation under heat, a method is known in which iron carbonyl is thermally decomposed to form iron particles. The protective colloid is preferably a polymer or a surfactant. The polymer may be, for example, polyvinyl alcohol (PVA), poly-N-vinyl-2-pyrrolidone (PVP), or gelatin, and is preferably PVP. The molecular weight of the polymer is preferably from 20,000 to 60,000, and is more preferably from 30,000 to 50,000. The amount of the polymer is preferably from 0.1 to 10 times (more preferably from 0.1 to 5 times) the mass of hard magneticnanoparticles to be produced.

The surfactant which is preferably used as the protective colloid preferably contains an “organic stabilizer” which is a long-chain organic compound represented by the formula: R—X. R in the formula represents a “tail group” which is a straight-chain or branched hydrocarbon or fluorocarbon chain, and usually contains 8 to 22 carbon atoms. X in the formula represents a “head group” which is a portion (X) providing a specific chemical bond to the surfaces of nanoparticles, and is preferably any of sulfinate (—SOOH), sulfonate (—SO₂OH), phosphinate (—POOH), phosphonate (—OPO(OH)₂), carboxylate, or thiol.

The organic stabilizer is preferably any of a sulfonic acid (R—SO₂OH), a sulfinic acid (R—SOOH), a phosphinic acid (R₂POOH), a phosphonic acid (R—OPO(OH)₂), a carboxylic acid (R—COOH), or a thiol (R—SH). Oleic acid is particularly preferred.

Oleic acid is a surfactant well known in the stabilization of a colloid, and is suitable for protecting iron nanoparticles. Oleic acid has an 18-carbon chain with a length of about 20 angstroms (about 2 nm). Oleic acid is not aliphatic, and has one double bond. The relatively long chain of oleic acid gives important steric hindrance that cancels the strong magnetic interaction between the particles. Similar long-chain carboxylic acids, such as erucic acid and linolic acid, have also been used similarly to oleic acid (for example, one or more long-chain organic acids having 8 to 22 carbon atoms can be used). Oleic acid is particularly preferable because it is an inexpensive natural resource which is easily available (from olive oil, etc.).

The combination of phosphine and organic stabilizer (triorganophosphine/acid, etc.) provides excellent controllability for the growth and stabilization of particles. Phenyl or n-octyl ether is suitable as a solvent owing to its low cost and high boiling point. Didecyl ether and didodecyl ether are also usable.

The reaction is preferably carried out at a temperature of from 80° C. to 360° C., and more preferably from 80° C. to 240° C., depending on the desired iron particles and the boiling point of the solvent. When the temperature is below the range, particle growth does not occur in some cases. When the temperature is above the range, particles growth is uncontrolled, thereby increasing the formation of undesirable by-products in some cases.

It is preferable to employ a seed crystal method so as to realize a large particle size. It is preferable to hydrogenate iron particles used as seed crystals so as to avoid oxidation.

The removal of salts from the solution after the synthesis of iron particles is desirable in terms of improvement of the dispersion stability of iron nanoparticles. Salts can be removed by adding excess alcohol to the solution to cause light coagulation, allowing the coagulated matter to sediment naturally or centrifugally, and removing the salts together with the supernatant. However, this method is likely to cause coagulation, and thus it is preferable to employ ultrafiltration.

The particles before nitriding are preferably pure iron particles, and are preferably subjected to reduction treatment as necessary. The reduction treatment can be performed by heating in a hydrogen gas atmosphere. The temperature at the heating is preferably from 200° C. to 350° C. When the temperature is above 350° C., fusion of the particles may occur.

(2) Nitriding Process:

In the nitriding process, iron particles are heated in a gas stream containing nitrogen. This process produces Fe₁₆N₂ phase as a principal phase. However, if there is a possibility of oxidation of iron particles, it is preferable to carry out reduction treatment in hydrogen or a mixed gas stream of hydrogen and an inert gas (e.g. H₂, Ar or He) (reduction treatment) prior to the nitriding treatment. In the reduction, an excessively high temperature is undesirable as it causes the fusion of particles, and an excessively low temperature fails to cause sufficient reduction. Accordingly, the temperature is preferably from 200° C. to 300° C., and more preferably from 250° C. to 300° C.

The nitrogen-containing gas for the nitriding treatment may be nitrogen gas, a mixture of nitrogen and hydrogen gases, ammonia gas, or the like. Use of ammonia gas can be convenient.

Nitriding treatment in an NH₃ atmosphere is preferably performed in an ammonia (NH₃) gas stream or a mixed gas stream containing ammonia gas (for example, a mixed gas containing ammonia gas and at least one of argon, hydrogen and nitrogen gases), and at a relatively low temperature in the range of 100° C. to 250° C. A higher nitriding temperature makes it difficult to form Fe₁₆N₂ phase. When the nitriding temperature is too low, the formation of Fe₁₆N₂ phase tends to take longer time. It is desirable for those gases to have a high purity (SN or higher) or an oxygen content of several ppm or less. In the temperature range of 100° C. to 250° C., the duration of the nitriding treatment is preferably in a range of 0.5 to 24 hours from the industrial view point, and is more preferably from 0.5 to 12 hours, though the duration depends on the particle diameter.

It is desirable to select the conditions of the nitriding treatment such that the magnetic powder obtained has a nitrogen content of 1.0 to 20 atom % relative to iron. When the content of nitrogen is too low, the amount of Fe₁₆N₂ produced is small, thus reducing the improvement in coercive force. When the content of nitrogen is too high, Fe₄N or Fe₃N phase easily forms, whereby the coercive force is decreased and the saturation magnetization is excessively weakened.

(3) Oxide Layer Formation:

The oxide layer forming process is an optional process in which an oxide layer is formed on Fe₁₆N₂ particles as necessary. The formation of an oxide layer is preferably accomplished by a treatment for 1 to 10 hours at a temperature of 0° C. to 100° C. in an inert gas atmosphere (e.g. N₂, Ar, He or Ne) having an oxygen content of 1 to 5%. By such a treatment, an oxide layer having a thickness as described below can be provided.

The coating of particles with a rare earth element may usually be accomplished by dispersing the starting material in an aqueous alkali or acid solution, dissolving a salt of the rare earth element therein, and causing a hydroxide or hydrate containing the rare earth element to deposit on the particles mainly containing Fe₁₆N₂ by neutralization or the like.

The coating of particles mainly containing Fe₁₆N₂ with silicon, aluminum, etc. may be accomplished by immersing those particles in a solution of a compound composed of one or more elements selected from silicon, aluminum, and optionally boron, phosphorus, and the like. Additives, such as a reducing agent, a pH buffer agent, and a particle diameter controller, may be added to carry out the coating treatment efficiently. In an exemplary coating treatment, a rare earth element and silicon, aluminum, or the like are applied simultaneously or alternately.

The magnetic particles produced as described above contain Fe₁₆N₂ as a principal phase (an Fe₁₆N₂ phase occupying at least a half) and are substantially spherical. When iron having a body-centered cubic crystal structure is nitrided, one of its three equivalent axes extends to form a body-centered tetragonal crystal structure and the extended axis forms the axis of easy magnetization. Therefore, it undesirably follows that when needle-shaped iron particles are nitrided to form Fe₁₆N₂, some particles have an axis of easy magnetization along their major axis while other particles have an axis of easy magnetization along their minor axis. More specifically, the particles have a problem of surface roughening when oriented in a magnetic field. Iron nitride magnetic particles having a principal phase of Fe₁₆N₂ preferably have an average particle diameter of 5 to 25 nm, more preferably from 8 to 15 nm, and still more preferably from 9 to 11 nm. When the particle diameter is larger than the above range, the particles tend to be soft magnetic. When the particle diameter is smaller than the above range, the particles tend to be superparamagnetic.

(2) Magnetic Particles:

The magnetic particles of the present invention contain at least an Fe₁₆N₂ phase having an average particle diameter of 9 to 11 nm and their particle diameters have a variation coefficient of 15% or less. The average particle diameter of the Fe₁₆N₂ phase is the diameter of the Fe₁₆N₂ particles themselves excluding the layer(s) (if any) formed on their surfaces.

The magnetic particles of the present invention contain at least an Fe₁₆N₂ phase and preferably does not contain any other iron nitride phase. The reason is that the Fe₁₆N₂ phase has a high crystalline magnetic anisotropy of 2×10⁶ to 7×10⁶ erg/cc, while the crystalline magnetic anisotropy of iron nitride (Fe₄N or Fe₃N phase) is about 1×10⁵ erg/cc. Thus, the magnetic particles of the present invention are able to maintain a high coercive force even in the form of fine particles. The high crystalline magnetic anisotropy of the Fe₁₆N₂ phase derives from its crystal structure. Its crystal structure is a body-centered tetragonal structure having N atoms disposed in a regular pattern between the octahedral lattices of Fe, and the strain produced by the N atoms disposed in the lattices is considered to be the cause of the strong crystalline magnetic anisotropy. The easy magnetization axis of the Fe₁₆N₂ phase is the c-axis extended by nitriding.

The particles containing the Fe₁₆N₂ phase are preferably granular or oval in shape. They are more preferably spherical. One of the three equivalent directions of α-Fe having a cubic crystal structure is selected by nitriding as the c-axis (axis of easy magnetization); therefore, needle-shaped particles are undesirable since it undesirably follows that some particles have an axis of easy magnetization along their major axis, while other particles have an axis of easy magnetization along their minor axis. Thus, the average of the ratio of the length of the major axis to the length of the minor axis is preferably 2 or less (for example, from 1 to 2), and is more preferably 1.5 or less (for example, from 1 to 1.5).

The particle diameter is determined by the particle diameter of iron particles before nitriding, and is preferably monodispersed. The reason is that monodispersed particles enable reduction in the medium noise in general. The particle diameter of iron nitride magnetic powder containing a principal phase of Fe₁₆N₂ is governed by the particle diameter of iron particles and the iron particles preferably have a monodispersed particle diameter distribution. The reason is that large and small particles have different degrees of nitriding and different magnetic properties. Thus, the iron nitride magnetic powder preferably has a monodispersed particle diameter distribution.

The Fe₁₆N₂ phase as a magnetic material may have a particle diameter of 9 to 11 nm. Particles having a smaller diameter are more easily affected by thermal fluctuations and become superparamagnetic, and are unsuitable for a magnetic recording medium. Moreover, their magnetic viscosity produces a high coercive force at the time of high-speed recording with a head and makes recording difficult. If the particles have a larger diameter, their saturation magnetization cannot be reduced, and thus they have so high a coercive force at the time of recording that recording is difficult. Moreover, a larger particle size results in a magnetic recording medium with a higher level of noise derived from the particles. The particles are preferably monodispersed in particle diameter distribution. The reason is that monodispersed particles enable a reduction in the medium noise in general. Their particle diameter preferably has a variation coefficient of 15% or less (preferably from 2 to 15%), and more preferably 10% or less (preferably from 2 to 10%).

The particle diameter and its variation coefficient can be calculated from the arithmetic mean particle diameter as determined by a particle diameter measuring instrument (product of Carl Zeiss, KS-300) from a negative photograph of ×100,000 magnifications taken through a TEM (product of Nippon Denshi (JEOL Ltd.), 1200EX) of diluted alloy nanoparticles dried on a 200 mesh of Cu having a carbon film attached thereto.

The particles containing an Fe₁₆N₂ phase preferably have a nitrogen content of 1.0 to 20.0 atom %, more preferably 5.0 to 18.0 atom % and still more preferably 8.0 to 15.0 atom % relative to iron. Too little nitrogen forms only a small amount of Fe₁₆N₂. Since a high coercive force is based on the strain by nitriding, little nitrogen results in a low coercive force. If there is too much nitrogen, the Fe₁₆N₂ phase, which is a metastable phase, is decomposed into a stable phases of other nitrides, resulting in an excessive reduction of saturation magnetization.

The term “variation coefficient of particle diameter” as used herein means a value obtained by dividing the standard deviation of the distribution of the particle diameter (the diameter of the corresponding circle) by the average particle diameter. The “variation coefficient of composition” means a value obtained by dividing the standard deviation of the distribution of the composition of alloy nanoparticles by the average composition, in a similar way to the calculation of the variation coefficient of the particle diameter. According to the present invention, those values are expressed in terms of % by being multiplied by 100.

The average particle diameter and its variation coefficient can be calculated from the arithmetic mean particle diameter as determined by a particle diameter measuring instrument (product of Carl Zeiss, KS-300) from a negative photograph of ×100,000 magnifications taken through a TEM (product of Nippon Denshi (JEOL Ltd.), 1200EX) of diluted alloy nanoparticles dried on a 200 mesh of Cu having a carbon film attached thereto.

The surface of iron nitride magnetic powder containing a principal phase of Fe₁₆N₂ is preferably covered with an oxide layer. The reason is that fine particles of Fe₁₆N₂ are easily oxidized, and thus handling of the fine particles has to be conducted in a nitrogen atmosphere.

The oxide layer preferably contains a rare earth element and/or an element selected from silicon or aluminum. Such an oxide layer enables the particles to have surfaces similar to those of ordinary metal particles consisting mainly of iron and cobalt, and gives a high compatibility with the processes handling metal particles. As to the rare earth element, Y, La, Ce, Pr, Nd, Sm, Yb, Dy or Gd is preferably used, and Y is particularly preferable in view of dispersibility.

Beside silicon or aluminum, boron or phosphorus may be introduced as necessary. The coating may further contain carbon, calcium, magnesium, zirconium, barium, strontium, or the like as effective elements. A higher level of shape retention and dispersibility can be achieved by the combination of these additional elements with a rare earth element and/or silicon or aluminum.

In the composition of the surface compound layer, the total content of rare earth elements, boron, silicon, aluminum and phosphorus relative to iron is preferably from 0.1 to 40.0 atom %, more preferably from 1.0 to 30.0 atom %, and still more preferably from 3.0 to 25.0 atom %. A shortage of those elements makes it difficult to form a surface compound layer, and thereby results in decreased magnetic anisotropy and inferior oxidation stability. When the amount of those elements is too large, the saturation magnetization tends to be decreased excessively.

The oxide layer preferably has a thickness of 1 to 5 nm, and more preferably 2 to 3 nm. When the thickness is smaller than the above range, the oxidation stability tends to be low. When the thickness is larger than the above range, the particle size is practically hard to reduce.

As regards the magnetic properties of nitride iron magnetic particles containing a principal phase of Fe₁₆N₂, their coercive force (Hc) is preferably from 79.6 to 318.4 kA/m (1,000 to 4,000 Oe), more preferably from 159.2 to 278.6 kA/m (2,000 to 3,500 Oe), still more preferably from 197.5 to 237 kA/m (2,500 to 3,000 Oe). When Hc is too low, the particles tend to be unsuitable for high recording density due to the influence of adjoining recording bits in the case of, for example, in-plane recording. When Hc is too high, recording is difficult in some cases.

Their Ms-V value is preferably from 5.2×10⁻¹⁶ to 6.5×10⁻¹⁶. Saturation magnetization Ms in the value Ms·V can be measured by using, for example, a vibrating sample magnetometer (VSM). Volume V can be determined by examining particles through a transmission electron microscope (TEM), determining the particle diameter of the Fe₁₆N₂ phase, and converting the measured value to the volume.

Their saturation magnetization is preferably from 80 to 160 Am²/kg (80 to 160 emu/g), and more preferably from 80 to 120 Am²/kg (80 to 120 emu/g). If the saturation magnetization is too low, signals are weak in some cases. If the saturation magnetization is too high, the particles may not be suitable for high density recording because of the influence on adjoining recording bits in the case of, for example, in-plane recording. The squareness ratio is preferably from 0.6 to 0.9.

The magnetic powder preferably has a BET specific surface area of 40 to 100 m²/g. If its BET specific surface area is too small, the particle size is large, and noise derived from the particles is high when applied to a magnetic recording medium, and the surface smoothness of the magnetic layer is decreased, resulting in low reproduction output. If its BET specific surface area is too large, the particles containing a phase of Fe₁₆N₂ tend to coagulate, and it is difficult to obtain a uniform dispersion and a smooth surface.

The particles containing a phase of Fe₁₆N₂ are preferably manufactured by the method of the present invention as described above, but may alternatively be manufactured from synthesized α-Fe. A method of manufacturing the particles will now be described. A phase of Fe₁₆N₂ is obtained by nitriding α-Fe. α-Fe is obtained by reducing iron oxide or hydroxide (for example, hematite, magnetite or geothite) in a gaseous phase, or by synthesizing in a liquid phase. The average particle size of the iron oxide or hydroxide is not specifically limited, but is desirably from 5 to 100 nm. If the particle size is too small, sintering is likely to occur between particles during reduction treatment, if the particle size is too large, the reduction treatment tends to be nonhomogenous and the particle diameter, and magnetic properties are difficult to control.

Therefore, iron oxide or hydroxide is preferably coated with a rare earth element or a compound containing at least one element selected from boron, silicon, aluminum, phosphorus, and the like, to avoid sintering. The coating with a rare earth element can be accomplished by dispersing the starting material in an aqueous alkali or acid solution, dissolving a salt of the rare earth element therein, and causing a hydroxide or hydrate containing the rare earth element to deposit on the starting powder by neutralization or the like. The coating with a compound containing at least one element selected from boron, silicon, aluminum, phosphorus, and the like may be accomplished by dissolving the compound in a solution in which the starting powder is immersed, and causing the element to be adsorbed or deposited.

The hydroxide or hydrate may be coated, simultaneously or alternately, with a rare earth element and at least one element selected from among boron, silicon, aluminum, phosphorus, and the like. Additives, such as a reducing agent, a pH buffer agent, and a particle diameter controller, are preferably added to carry out the coating treatment efficiently.

Then, the hydroxide or hydrate coated with the compound is heated in a reducing gas stream. The reducing gas may be hydrogen or carbon monoxide gas. Hydrogen is preferred from an environmental standpoint, as it turns into H₂O after treatment. The reducing temperature is preferably from 250° C. to 600° C., more preferably from 300° C. to 500° C. If the reducing temperature is lower than 250° C., the reduction reaction does not proceed sufficiently. If the reducing temperature exceeds 600° C., the sintering of particles easily occur.

Thereafter, the nitriding and oxide layer forming processes are conducted to manufacture magnetic particles, similarly to the manufacturing method described above according to an aspect of the present invention.

(3) Magnetic Recording Medium:

The magnetic particles manufactured by the manufacturing method of the present invention are suitable for use for the magnetic layer of a magnetic recording medium. The magnetic recording medium may, for example, be a magnetic tape such as a video or computer tape, or a magnetic disk such as a FLOPPY (registered trademark) disk or hard disk.

The magnetic layer can be formed by coating a support with a layer composed mainly of Fe₁₆N₂ particles (magnetic particles). The support may be inorganic or organic if it is a support usable for a magnetic recording medium.

An inorganic support may comprise a material such as aluminum, a magnesium alloy such as Al—Mg or Mg—Al—Zn, glass, quartz, carbon, silicon or ceramics. These supports are excellent in impact resistance and have suitable rigidity for thickness reduction and high-speed rotation. They also have high heat resistance when compared with organic supports which will be mentioned below.

Examples of materials for organic supports include polyesters such as polyethylene terephthalate or polyethylene naphthalate, polyolefins, cellulose triacetate, polycarbonates, polyamides (including aliphatic polyamides and aromatic polyamides such as aramid), polyimides, polyamideimides, polysulfones, or polybenzoxazole.

The support may be coated by a method such as air doctor coating, blade coating, rod coating, extrusion coating, air knife coating, squeeze coating, impregnation coating, reverse roll coating, transfer roll coating, gravure coating, kiss coating, cast coating, spray coating, or spin coating.

The thickness of the magnetic layer to be formed is preferably from 4 nm to 1 μm, and more preferably from 4 to 100 nm, though the thickness depends on the kind of the magnetic recording medium.

The magnetic recording medium of the present invention may also have layers other than the magnetic layer, as necessary. For example, a disk preferably has a magnetic or non-magnetic layer formed on the opposite side to the side on which the magnetic layer is to be provided. A tape preferably has a back layer provided on the opposite side of the insoluble support to the magnetic layer.

A sufficiently reliable magnetic recording medium can be produced by forming a very thin protective layer on the magnetic layer to improve its wear resistance, and by coating the protective layer with a lubricant to elevate its sliding property.

Examples of the material for the protective film include oxides such as silica, alumina, titania, zirconia, cobalt oxide, and nickel oxide, nitrides such as titanium nitride, silicon nitride, and boron nitride, carbides such as silicon carbide, chromium carbide, and boron carbide, and carbons such as graphite and amorphous carbon. The material for the protective layer is preferably a hard amorphous carbon generally known as diamond-like carbon.

Carbon is suitable as a material for the protective film, since even a film having a very small thickness has sufficient wear resistance and renders sufficient seize resistance to sliding members. While sputtering is usually employed to form a carbon protective film on a hard disk, many methods using plasma CVD with a higher film-forming speed have been proposed for products (such as video tapes) on which a continuous film has to be formed. Accordingly, it is preferable to employ these methods. Plasma injection CVD (PI-CVD) is, among others, reported as achieving a very high film-forming speed and being able to form an excellent carbon protective film with hardness and fewer pinholes (see, for example, JP-A Nos. 61-130487, 63-279426, and3-113824).

The carbon protective film preferably has a Vickers hardness of 1,000 kg/mm² or higher, and more preferably 2,000 kg/mm² or higher. In a preferable embodiment, the crystal structure of the carbon is amorphous and electrically non-conductive.

When a diamond-like carbon film is used as the carbon protective film, its structure can be ascertained by Raman spectroscopy. Specifically, the analysis of a diamond-like carbon film reveals a peak in the range of 1,520 to 1,560 cm⁻¹. If the structure of the carbon film deviates from the diamond-like structure, the peak detected by Raman spectroscopy deviates from the range mentioned above and the hardness of the film (as a protective film) is decreased.

The carbon material for forming the carbon protective film is preferably a carbon-containing compound. Examples thereof include alkanes such as methane, ethane, propane, and butane, alkenes such as ethylene and propylene, and alkynes such as acetylene. Carrier gas such as argon, and gas for improving film quality, such as hydrogen or nitrogen, may be added as necessary.

When the carbon protective film is thick, the electromagnetic conversion characteristics are deteriorated, and the adhesion to the magnetic layer is weakened. When the carbon protective film is thin, the wear resistance is insufficient. Accordingly, the film thickness is preferably from 2.5 to 20 nm, and more preferably from 5 to 10 nm. It is preferable to subject the surface of the magnetic layer as a substrate to modification by etching with an inert gas or by exposure to a plasma of a reactive gas, such as oxygen, to improve the adhesion between the magnetic layer and the protective film.

The magnetic layer may have a multilayer structure, or may have a known non-magnetic underlying or intermediate layer thereunder to realize improved electromagnetic conversion characteristics. It is preferable to apply a lubricant and/or a rust preventive agent onto the magnetic layer or the protective film, thereby realizing improved running durability and corrosion resistance, as described above. The lubricant which can be added is, for example, a known hydrocarbon-based or fluorine-containing lubricant, or an extreme-pressure additive.

Examples of hydrocarbon-based lubricants include carboxylic acids such as stearic and oleic acids, esters such as butyl stearate, sulfonic acids such as octadecylsulfonic acid, phosphoric esters such as monooctadecyl phosphate, alcohols such as stearyl alcohol and oleyl alcohol, carboxylic acid amides such as stearic acid amide, and amines such as stearylamine.

The fluorine-containing lubricants may be obtained by substituting a fluoroalkyl or perfluoropolyether group for a part or all of the alkyl group in a hydrocarbon-based lubricant selected from the examples described above. Examples of the perfluoropolyether groups include perfluoromethylene oxide polymers, perfluoroethylene oxide polymers, perfluoro-n-propylene oxide polymers (CF₂CF₂CF₂O)ₙ, perfluoroisopropylene oxide polymers (CF(CF₃)CF₂O)ₙ, and copolymers thereof.

The hydrocarbon-based lubricant preferably has a polar functional group, such as a hydroxyl, ester or carboxyl group, at an end of the alkyl group or in the molecule since such a compound efficiently decreases frictional force. The molecular weight of the lubricant is preferably from 500 to 5,000, more preferably from 1,000 to 3,000. Compounds having a molecular weight lower than 500 are highly volatile, and are low in lubricating property in some cases. Compounds having a molecular weight over 5,000 are so high in viscosity that the adhesion between a slider and a disk is likely to occur, which sometimes results in frequent jamming up whilst running or head crash. Specific examples of perfluoropolyethers are sold, for example by Ausimont and DuPont under the trade names of FOMBLIN and KRYTOX, respectively.

Examples of extreme-pressure additives include phosphoric esters such as trilauryl phosphate, phosphorous esters such as trilauryl phosphite, thiophosphorous or thiophosphoric esters such as trilauryl trithiophosphite, and sulfur-based extreme-pressure agents such as dibenzyl disulfide.

Only a single lubricant may be used, or two or more lubricants may be used in combination. Such a lubricant can be applied onto the magnetic layer or the protective film by being dissolved in organic solvent and applied by a method (such as wire bar, gravure, spin or dip coating), or by vacuum vapor deposition.

Examples of rust preventive agents include nitrogen-containing heterocycles such as benzotriazole, benzoimidazole, purine and pyrimidine, derivatives obtained by introducing alkyl side chains, etc. into the nuclei of such nitrogen-containing heterocycles, nitrogen- and sulfur-containing heterocycles such as benzothiazole, 2-mercaptobenzothiazole, tetrazaindene ring compounds and thiouracil compounds, and derivatives thereof.

When the magnetic recording medium is a magnetic tape, a backcoat layer (backing layer) may be provided on the side of the non-magnetic support that does not have a magnetic layer thereon, as described above. The backcoat layer is a layer formed by coating the side of the non-magnetic support that does not have a magnetic layer thereon with a backcoat layer forming paint prepared by dispersing granular components—such as an abrasive and an antistatic agent—and a binder in a known organic solvent. Various kinds of inorganic pigments and carbon black may be used as the granular components. The binder may be a resin, such as nitrocellulose, phenoxy resin, a vinyl chloride resin, or a polyurethane resin, or a mixture thereof. A known adhesive layer may be formed on the surface to be coated with a alloy-particles-containing solution and/or on the surface on which a backcoat layer is to be provided.

The magnetic recording medium manufactured as described above preferably has a centerline average surface roughness of 0.1 to 5 nm and more preferably 1 to 4 nm at a cutoff value of 0.25 mm. A surface having such a high level of smoothness is suitable for a magnetic recording medium for high-density recording. Such a surface can be formed by conducting calendering after the formation of the magnetic layer. Varnishing may also be employed.

The magnetic recording medium obtained can be used after punching by a punching machine, or cutting into a desired size by a cutting machine or the like.

Exemplary embodiments of the present invention are described below:

<1> A method of manufacturing magnetic particles, the method comprising synthesizing iron particles in a liquid phase, nitriding the iron particles, adjusting the average particle diameter to 5 to 25 nm, and making the iron particles substantially spherical.

<2> The method of manufacturing magnetic particles described in <1>, wherein the synthesis of the iron particles comprises conducting a reduction reaction by mixing a reverse micelle solution (II) and a reverse micelle solution (I), wherein the reverse micelle solution (II) is prepared by mixing a water-insoluble organic solvent containing a surfactant and an aqueous solution of a reducing agent, and the reverse micelle solution (I) is prepared by mixing a water-insoluble organic solvent containing a surfactant and an aqueous solution of a salt of iron.

<3> The method of manufacturing magnetic particles described in <1>, further comprising forming an oxide layer.

<4> The method of manufacturing magnetic particles described in <2>, wherein the surfactant is an oil-soluble surfactant.

<5> The method of manufacturing magnetic particles described in <2>, wherein the aqueous solution of the salt of iron contains a chelating agent.

<6> The method of manufacturing magnetic particles described in <2>, wherein each of the reverse micelle solutions (I) and (II) has a water/surfactant ratio in a range of 0.5 to 20.

<7> The method of manufacturing magnetic particles described in <2>, wherein the reduction reaction is conducted at a constant temperature in a range of −5° C. to 30° C.

<8> The method of manufacturing magnetic particles described in <2>, wherein the reduction reaction is conducted while stirring at a rate of 3,000 rpm or higher.

<9> The method of manufacturing magnetic particles described in <2>, wherein after the reduction reaction, at least one dispersant having one to three groups selected from amino-groups and carboxyl groups is added in an amount of 0.001 to 10 moles per mole of the iron particles to be produced.

<10> The method of manufacturing magnetic particles described in <9>, wherein the dispersant has 1 to 3 groups selected from amino, carboxyl, sulfonate and sulfinate groups.

<11> The method of manufacturing magnetic particles described in <2>, wherein after the reduction reaction, the iron particles are ripened for 5 to 180 minutes at a constant temperature in a range of 30° C. to 90° C.

<12> The method of manufacturing magnetic particles described in <2>, wherein the iron particles are reduced in hydrogen or a mixed gas stream of hydrogen and an inert gas prior to nitriding.

<13> Magnetic particles containing at least a Fe₁₆N₂ phase having an average particle diameter of 9 to 11 nm and a particle diameter variation coefficient of 15% or less.

<14> The magnetic particles described in <13>, wherein the magnetic particles are free from any phase of iron nitride other than the phase of Fe₁₆N₂.

<15> The magnetic particles described in <13>, wherein the content of nitrogen is 1.0 to 20.0 atom % relative to iron.

<16> The magnetic particles described in <13>, wherein the content of nitrogen is 8.0 to 15.0 atom % relative to iron.

<17> The magnetic particles described in <13>, wherein surfaces of the magnetic particles have an oxide layer having a thickness of 1 to 5 nm.

<18> The magnetic particles having a Fe₁₆N₂ phase with a coercive force of 197.5 to 237 kA/m (2,500 to 3,000 Oe) and a Ms·V value of 5.2×10⁻¹⁶ to 6.5×10⁻¹⁶.

<19> A magnetic recording medium containing magnetic particles described in <13> in a magnetic layer.

<20> A magnetic recording medium containing magnetic particles described in <18> in a magnetic layer.

### EXAMPLES

The present invention will now be described more specifically by Examples, though the present invention is not limited by the Examples.

### Examples 1 to 13

The following operation was carried out in high purity N₂ gas. An alkane solution obtained by dissolving AEROSOL OT (whose amount is shown in Table 1 below) in 80 ml of decane was added to and mixed with an aqueous solution of a metal salt obtained by dissolving 0.35 g of triammonium iron trioxalate (Fe(NH₄)₃(C₂O₄)₃, product of Wako Pure Chemical Industries Ltd.) in 24 ml of H₂O (deoxidized) to prepare a reverse micelle solution (I).

An alkane solution obtained by dissolving AEROSOL OT (whose amount is shown in Table 1, product of Wako Pure Chemical Industries Ltd.) in 40 ml of decane (product of Wako Pure Chemical Industries Ltd.) was added to and mixed with an aqueous solution of a reducing agent obtained by dissolving 0.57 g of NaBH₄ (product of Wako Pure Chemical Industries Ltd.) in 12 ml of H₂O (deoxidized) to prepare a reverse micelle solution (II).

The reverse micelle solution (I) was added instantaneously into the reverse micelle solution (II) under stirring with OMNIMIXER (product of Yamato Kagaku) at a high speed at a temperature of 22° C. Five minutes after the addition, the stirrer was changed to a magnetic stirrer, and the solution was heated to 40° C. and allowed to undergo 120 minutes of ripening. After the solution was cooled to room temperature, 2 ml of oleic acid (product of Wako Pure Chemical Industries Ltd.) was added to and mixed with the solution.

A mixture of 200 ml of H₂O (deoxidized) and 200 ml of methanol was added to separate the water and oil phases to destroy micelles. A dispersion of metal nanoparticles was obtained in the oil phase. The oil phase was washed with 600 ml of H₂O and 200 ml of methanol five times. Then, 1,300 ml of methanol was added to cause alloy nanoparticles to undergo flocculation and precipitation. After the removal of the supernatant, 20 ml of heptane (product of Wako Pure Chemical Industries Ltd.) was added to disperse the particles again, and 100 ml of methanol was added to cause precipitation. This operation was repeated twice, and finally, 5 ml of heptane (product of Wako Pure Chemical Industries Ltd.) was added to produce a dispersion of iron nanoparticles having the particle diameter shown in Table 1 below. The dispersion of iron nanoparticles was degassed in a vacuum to yield a dispersion of iron nanoparticles in a dispersing agent (oleic acid, oleylamine).

Some of the samples (Examples 4 to 6, 9 and 10) were subjected to an hour of reduction treatment at 280° C. in a hydrogen gas stream (reduction treatment). Then, all the samples were subjected to 24 hours of nitriding treatment at 130° C. in a mixed gas stream formed by 100 ml/minute of NH₃ and 50 ml/minute of argon (nitriding treatment). Then, the samples were cooled to room temperature. Some of the samples (Examples 7 to 13) were then held at 25° C. for five hours in an atmosphere containing 99% of nitrogen and 1% of oxygen to undergo oxidizing treatment (oxide layer formation).

### Comparative Example 1

A sample of Comparative Example 1 was prepared in the same manner as Example 1 of JP-A No. 2000-277311.

### Comparative Example 2

A sample of Comparative Example 2 was prepared in the same manner as Example 1 of JP-A N. 2004-273094.

(Evaluation of Magnetic Properties)

The magnetic particles were enclosed in an acrylic case in a glove box under a nitrogen gas atmosphere, and were examined in an applied magnetic field of 790 kA/m (10 kOe) by using a high-sensitivity magnetization vector measuring machine and a data processing unit, both manufactured by Toei Industries Co., Ltd. The results (coercive forces) are shown in Table 1 below, together with the results of the following tests.

(Evaluation of Particle Diameter)

The variation coefficient of particle diameter was calculated from the arithmetic mean particle diameter as determined by a particle diameter measuring instrument (product of Carl Zeiss, KS-300) from a negative photograph of 100,000 magnifications taken through a TEM (product of Nippon Denshi (JEOL Ltd.), 1200EX) of diluted magnetic particles dried on a 200 mesh of Cu having a carbon film attached thereto. With respect to the particles having an oxide layer formed thereon, the thickness of the oxide layer was determined based on the contrast between the oxide layer and iron nitride.

(Spherical Degree)

The spherical degree (SFD) of magnetic particles was determined by determining the lengths of the major and minor axes from their TEM images and calculating the ratio, (major axis length)/(minor axis length). An SFD of 2 or less is considered to indicate that the particles are substantially spherical.

(Structural Analysis)

The analysis of the crystal structure was performed with an X-ray diffractometer manufactured by Rigaku Corporation at a tube voltage of 50 kV and a tube current of 300 mA using CuKα rays as a radiation source, in accordance with a powder method using a goniometer. The formation of Fe₁₆N₂ was confirmed in all of the samples.

(Ms·V)

Ms·V was determined as described below. The saturation magnetization Ms was first determined in an applied magnetic field of 790 kA/m (10 kOe) by using a high-sensitivity magnetization vector measuring machine and a data processing unit, both manufactured by Toei Industries Co., Ltd. The volume V of the particles was calculated by statistical processing from data obtained by a particle diameter measuring instrument (product of Carl Zeiss, KS-300) from a photograph of particles taken through a TEM (product of Nippon Denshi (JEOL Ltd.), 1200EX).

(Oxidation Stability)

The oxidation stability of magnetic particles was estimated by the degree of heat generated upon exposure to the air.

The evaluation of the sample of Comparative Example 1 with respect to magnetic properties and particle shape was conducted under nitrogen atmosphere.

TABLE 1

| | Amount of AEROSOL OT (ml) | | | | | |
|---|---|---|---|---|---|---|
| | Reverse | Reverse | | | Diameter | |
| | micelle | micelle | | | of Fe₁₆N₂ | oxide layer |
| | solution (I) | solution (II) | Reduction | Oxidation | particles (nm) | thickness (nm) |
| Example 1 | 6.0 | 3.0 | Not | Not | 11 | — |
| | | | conducted | conducted | | |
| Example 2 | 5.4 | 2.7 | Not | Not | 12 | — |
| | | | conducted | conducted | | |
| Example 3 | 5.0 | 2.5 | Not | Not | 13 | — |
| | | | conducted | conducted | | |
| Example 4 | 6.0 | 3.0 | 1 h | Not | 11 | — |
| | | | at 280° C. | conducted | | |
| Example 5 | 5.4 | 2.7 | 1 h | Not | 12 | — |
| | | | at 280° C. | conducted | | |
| Example 6 | 5.0 | 2.5 | 1 h | Not | 13 | — |
| | | | at 280° C. | conducted | | |
| Example 7 | 5.4 | 2.7 | Not | Conducted | 8 | 2 |
| | | | conducted | | | |
| Example 8 | 5.0 | 2.5 | Not | Conducted | 9 | 2 |
| | | | conducted | | | |
| Example 9 | 5.4 | 2.7 | 1 h | Conducted | 8 | 2 |
| | | | at 280° C. | | | |
| Example 10 | 5.0 | 2.5 | 1 h | Conducted | 9 | 2 |
| | | | at 280° C. | | | |
| Example 11 | 5.4 | 2.7 | 1 h | Conducted | 8 | 2 |
| | | | at 280° C. | | | |
| Example 12 | 5.0 | 2.5 | 1 h | Conducted | 9 | 2 |
| | | | at 280° C. | | | |
| Example 13 | 5.4 | 2.7 | 1 h | Conducted | 8 | 2 |
| | | | at 280° C. | | | |
| Comparative | — | — | — | — | 50 | — |
| Example 1 | | | | | | |
| Comparative | — | — | — | Conducted | 18 | 2 |
| Example 2 | | | | | | |

| | Particle | | | | | |
|---|---|---|---|---|---|---|
| | diameter | | | Saturation | Ms · V | |
| | variation | Coercive | | magnetization | (emu/ | Oxidation |
| | coefficient (%) | force (A/m) | SFD | (emu/g) | particle) | stability |
| Example 1 | 10 | 2.3 × 10⁵ | 0.40 | 190 | 9.8 × 10⁻¹⁶ | Moderate heat |
| | | | | | | generation |
| Example 2 | 8 | 2.4 × 10⁵ | 0.35 | 185 | 1.2 × 10⁻¹⁵ | Moderate heat |
| | | | | | | generation |
| Example 3 | 9 | 2.5 × 10⁵ | 0.30 | 195 | 1.7 × 10⁻¹⁵ | Moderate heat |
| | | | | | | generation |
| Example 4 | 10 | 2.4 × 10⁵ | 0.35 | 195 | 1.0 × 10⁻¹⁵ | Moderate heat |
| | | | | | | generation |
| Example 5 | 9 | 2.5 × 10⁵ | 0.35 | 180 | 1.2 × 10⁻¹⁵ | Moderate heat |
| | | | | | | generation |
| Example 6 | 8 | 2.6 × 10⁵ | 0.30 | 185 | 1.6 × 10⁻¹⁵ | Moderate heat |
| | | | | | | generation |
| Example 7 | 12 | 2.1 × 10⁵ | 0.40 | 90 | 6.0 × 10⁻¹⁶ | No heat |
| | | | | | | generation |
| Example 8 | 13 | 2.2 × 10⁵ | 0.40 | 95 | 8.1 × 10⁻¹⁶ | No heat |
| | | | | | | generation |
| Example 9 | 12 | 2.1 × 10⁵ | 0.35 | 95 | 6.4 × 10⁻¹⁶ | No heat |
| | | | | | | generation |
| Example 10 | 14 | 2.1 × 10⁵ | 0.40 | 90 | 7.7 × 10⁻¹⁶ | No heat |
| | | | | | | generation |
| Example 11 | 12 | 2.0 × 10⁵ | 0.35 | 50 | 3.4 × 10⁻¹⁶ | No heat |
| | | | | | | generation |
| Example 12 | 14 | 2.5 × 10⁵ | 0.40 | 45 | 3.8 × 10⁻¹⁶ | No heat |
| | | | | | | generation |
| Example 13 | 12 | 2.1 × 10⁵ | 0.35 | 95 | 6.4 × 10⁻¹⁶ | No heat |
| | | | | | | generation |
| Comparative | 31 | 1.8 × 10⁵ | 0.95 | 185 | 6.7 × 10⁻¹⁴ | Ignition |
| Example 1 | | | | | | |
| Comparative | 30 | 2.6 × 10⁵ | 0.90 | 135 | 9.0 × 10⁻¹⁴ | Moderate heat |
| Example 2 | | | | | | generation |

As is obvious from the results shown in Table 1, the samples of the Examples according to the present invention were fine, monodispersed and stable magnetic particles.

### Examples 14 to 20

(Manufacture of a Magnetic Recording Medium)

A coating solution for a non-magnetic undercoat layer was prepared by kneading the following materials for the undercoat layer in an open kneader, subjecting the kneaded mixture to 60 minutes of dispersion treatment in a sand mill, adding 6 parts of polyisocyanate to the dispersion, and filtering it under stirring. A coating solution for a magnetic layer was separately prepared by kneading in an open kneader the following components for a magnetic paint including the magnetic particles of Example 1, subjecting the kneaded mixture to 45 minutes of dispersion in a sand mill, adding the curing agent described below to the dispersion, and mixing the dispersion.

<Materials for a Non-Magnetic Undercoat Layer>

| | |
|---|---|
| Iron oxide powder (average particle diameter: 55 nm): | 70 parts |
| Aluminum oxide powder (average particle diameter: 80 nm): | 10 parts |
| Carbon black (average particle diameter: 25 nm): | 20 parts |
| Vinyl chloride-hydroxypropyl methacrylate copolymer resin | 10 parts |
| (containing 0.7 × 10⁻⁴ equivalent of —SO₃Na group | |
| per gram): | |
| Polyesterpolyurethane resin (containing 1.0 × 10⁻⁴ | 5 parts |
| equivalent of —SO₃Na group per gram): | |
| Methyl ethyl ketone: | 130 parts |
| Toluene: | 80 parts |
| Myristic acid: | 1 part |
| Butyl stearate: | 1.5 parts |
| Cyclohexanone: | 65 parts |

<Components of a Magnetic Paint>

| | |
|---|---|
| Iron nitride magnetic powder shown in Table 2 below: | 100 parts |
| Vinyl chloride-hydroxypropyl acrylate copolymer resin | 8 parts |
| (containing 0.7 × 10⁻⁴ equivalent of —SO₃Na group | |
| per gram): | |
| Polyesterpolyurethane resin (containing 1.0 × 10⁻⁴ | 4 parts |
| equivalent of —SO₃Na group per gram): | |
| α-alumina (average particle diameter: 80 nm): | 10 parts |
| Carbon black (average particle diameter: 25 nm): | 1.5 parts |
| Myristic acid: | 1.5 parts |
| Methyl ethyl ketone: | 133 parts |
| Toluene: | 100 parts |

<Curing Agent>

| | |
|---|---|
| Stearic acid: | 1.5 parts |
| Polyisocyanate (CORONATE L manufactured by Nippon | 4 parts |
| Polyurethane Industry Co., Ltd.): | |
| Cyclohexanone: | 133 parts |
| Toluene: | 33 parts |

The coating solution for a non-magnetic undercoat layer described above was applied onto a polyethylene naphthalate film (showing a thermal shrinkage of 0.8% along its length and 0.6% along its width after 30 minutes of exposure to a temperature of 105° C.) having a thickness of 6 μm, which is a non-magnetic support, to form a non-magnetic undercoat layer having a thickness of 2 μm after drying and calendaring. The coating solution for a magnetic layer described above was further applied onto the non-magnetic undercoat layer, to form a magnetic layer having a thickness of 80 nm after magnetic field orientation, drying, and calendaring.

Then, a backcoat paint was applied onto the side of the non-magnetic support opposite to side having the non-magnetic undercoat layer and the magnetic layer, to form a backcoat layer having a thickness of 700 nm after drying and calendaring. The backcoat paint had been prepared by subjecting the following components for the backcoat paint to 45 minutes of dispersion treatment in a sand mill, adding 8.5 parts of polyisocyanate to the dispersion, and filtering it under stirring.

<Components of a Backcoat Paint>

| | |
|---|---|
| Carbon black (average particle diameter: 25 nm): | 40.5 parts |
| Carbon black (average particle diameter: 370 nm): | 0.5 part |
| Barium sulfate: | 4.05 parts |
| Nitrocellulose: | 28 parts |
| Polyurethane resin (containing SO₃Na group): | 20 parts |
| Cyclohexanone: | 100 parts |
| Toluene: | 100 parts |
| Methyl ethyl ketone: | 100 parts |

The magnetic sheet thus obtained was given a mirror finish by a five-stage calendar (at a temperature of 70° C. and a line pressure of 150 kg/cm), and was subjected to 48 hours of thermo treatment at a temperature of 60° C. and a relative humidity of 40%. Then, the magnetic sheet was cut into a width of ½ inch. Then, the surface of the magnetic layer was ground by a diamond wheel (rotating at a speed of 150% and having a winding angle of 30°) while the magnetic sheet was running at a speed of 100 m/min, so that a magnetic tape having a length of 609 m was obtained. The magnetic tape was incorporated in a cartridge to make a computer tape.

(Determination of Electromagnetic Conversion Characteristics)

The electromagnetic conversion characteristics of each sample were determined by using a Hewlett-Packard LTO drive. Specifically, each sample underwent five runs at a temperature of 40° C. and a relative humidity of 5%, then random data signals with a shortest recording wavelength of 0.33 μm was recorded on the sample, then the output of a reproduction head was read, and the output was converted to a relative value as compared with the output of the sample of Example 18 as the standard. The results are shown in Table 2.

TABLE 2

| | Iron nitride magnetic powder | Output |
|---|---|---|
| Example 14 | Magnetic particles of Example 7 | 0.85 |
| Example 15 | Magnetic particles of Example 8 | 0.77 |
| Example 16 | Magnetic particles of Example 9 | 0.97 |
| Example 17 | Magnetic particles of Example 10 | 0.8 |
| Example 18 | Magnetic particles of Example 11 | 1 |
| Example 19 | Magnetic particles of Example 12 | 0.95 |
| Example 20 | Magnetic particles of Example 13 | 0.8 |

It is obvious from the results shown in Table 2 that a high output can be obtained by using particles whose volume V, saturation magnetization Ms and coercive force Mc fall within the predetermined ranges (which realize Fe₁₆N₂ phase having an average particle diameter of 9 to 11 nm and a particle diameter variation coefficient of 15% or less).

The present invention provides a method of manufacturing magnetic particles which have a high coercive force and are monodispersed in diameter and uniform in magnetic properties. The present invention also provides magnetic particles which have a high coercive force, and are monidispersed in diameter and uniform in magnetic properties, and a magnetic recording medium containing such magnetic particles in a magnetic layer.

All publications, patent applications, and technical standards mentioned in this specification are herein incorporated by reference to the same extent as if each individual publication, patent application, or technical standard was specifically and individually indicated to be incorporated by reference.

What is claimed is:

1. A method of manufacturing magnetic particles, the method comprising synthesizing iron particles in a liquid phase, nitriding the iron particles, adjusting the average particle diameter to 5 to 25 nm, and making the iron particles substantially spherical.

2. The method of manufacturing magnetic particles described in claim 1, wherein the synthesis of the iron particles comprises conducting a reduction reaction by mixing a reverse micelle solution (II) and a reverse micelle solution (I), wherein the reverse micelle solution (II) is prepared by mixing a water-insoluble organic solvent containing a surfactant and an aqueous solution of a reducing agent, and the reverse micelle solution (I) is prepared by mixing a water-insoluble organic solvent containing a surfactant and an aqueous solution of a salt of iron.

3. The method of manufacturing magnetic particles described in claim 1, further comprising forming an oxide layer.

4. The method of manufacturing magnetic particles described in claim 2, wherein the surfactant is an oil-soluble surfactant.

5. The method of manufacturing magnetic particles described in claim 2, wherein the aqueous solution of the salt of iron contains a chelating agent.

6. The method of manufacturing magnetic particles described in claim 2, wherein each of the reverse micelle solutions (I) and (II) has a water/surfactant ratio in a range of 0.5 to 20.

7. The method of manufacturing magnetic particles described in claim 2, wherein the reduction reaction is conducted at a constant temperature in a range of −5° C. to 30° C.

8. The method of manufacturing magnetic particles described in claim 2, wherein the reduction reaction is conducted while stirring at a rate of 3,000 rpm or higher.

9. The method of manufacturing magnetic particles described in claim 2, wherein after the reduction reaction, at least one dispersant having one to three groups selected from amino groups and carboxyl groups is added in an amount of 0.001 to 10 moles per mole of the iron particles to be produced.

10. The method of manufacturing magnetic particles described in claim 9, wherein the dispersant has 1 to 3 groups selected from amino, carboxyl, sulfonate and sulfinate groups.

11. The method of manufacturing magnetic particles described in claim 2, wherein after the reduction reaction, the iron particles are ripened for 5 to 180 minutes at a constant temperature in a range of 30° C. to 90° C.

12. The method of manufacturing magnetic particles described in claim 2, wherein the iron particles are reduced in hydrogen or a mixed gas stream of hydrogen and an inert gas prior to nitriding.

13. Magnetic particles containing at least a Fe₁₆N₂ phase having an average particle diameter of 9 to 11 nm and a particle diameter variation coefficient of 15% or less.

14. The magnetic particles described in claim 13, wherein the magnetic particles are free from any phase of iron nitride other than the phase of Fe₁₆N₂.

15. The magnetic particles described in claim 13, wherein the content of nitrogen is 1.0 to 20.0 atom % relative to iron.

16. The magnetic particles described in claim 13, wherein the content of nitrogen is 8.0 to 15.0 atom % relative to iron.

17. The magnetic particles described in claim 13, wherein surfaces of the magnetic particles have an oxide layer having a thickness of 1 to 5 nm.

18. The magnetic particles according to claim 13, wherein the Fe₁₆N₂ phase has a coercive force of 197.5 to 237 kA/m (2,500 to 3,000 Oe) and a Ms·V value of 5.2×10⁻¹⁶ to 6.5×10⁻¹⁶.

19. A magnetic recording medium containing magnetic particles described in claim 13 in a magnetic layer.

20. A magnetic recording medium containing magnetic particles described in claim 18 in a magnetic layer.
